(19) United States
(12) Patent Application Publication
(10) Pub. No.: US 2014/0133801 A1
(43) Pub. Date: May 15, 2014

(54) LIGHT RECEPTACLE AND OPTICAL MODULE EQUIPPED WITH SAME

(71) Applicants: Shinya Kanke, Kawaguchi-shi (JP); Shimpei Morioka, Kawaguchi-shi (JP)

(72) Inventors: Shinya Kanke, Kawaguchi-shi (JP); Shimpei Morioka, Kawaguchi-shi (JP)

(73) Assignee: ENPLAS CORPORATION, Kawaguchi-shi, Saitama (JP)

(21) Appl. No.: 14/130,289

(22) PCT Filed: Jul. 13, 2012
(86) PCT No.: PCT/JP2012/067911

§ 371 Date: Dec. 30, 2013

(30) Foreign Application Priority Data
Jul. 15, 2011 (JP) 2011-156707

(51) Int. Cl. G02B 6/42

(52) U.S. Cl. CPC G02B 6/4212
USPC 385/33

(57) ABSTRACT

An optical receptacle includes a cylindrical optical fiber attaching section for attaching an end portion of an optical fiber, a cylindrical photoelectric conversion device attaching section for attaching a photoelectric conversion device having a light-receiving element, and a lens for optically coupling the end portion of the optical fiber and the light-receiving element. A face of the lens that faces the end portion of the optical fiber is formed into a planar face having a slope angle of 14 degrees to 16 degrees in relation to a virtual plane perpendicular to an optical axis of the lens.

### TECHNICAL FIELD

The present invention relates to an optical receptacle and an optical module including the optical receptacle. In particular, the present invention relates to an optical receptacle suitable for optically coupling an end portion of an optical fiber and a light-receiving element of a photoelectric conversion device, and an optical module including the optical receptacle.

### BACKGROUND ART

An optical module component referred to as an optical receptacle has been used in optical communication using optical fibers. The optical receptacle is configured such that an end portion of an optical fiber held within a cylindrical ferrule is inserted into the optical receptacle together with the ferrule and fixed thereto. In addition, a photoelectric conversion device having a photoelectric conversion element is attached to the optical receptacle. The optical receptacle onto which the photoelectric conversion device and the optical fiber are assembled in this way optically couples the photoelectric conversion element and the end portion of the optical fiber.

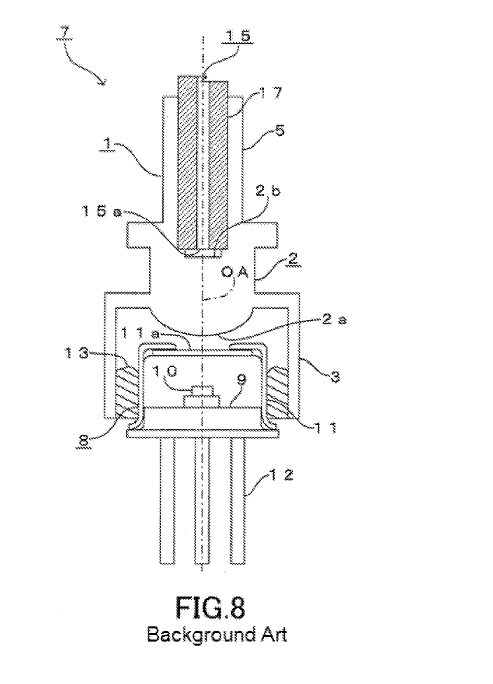

Here, FIG. 7 shows an example of this type of optical receptacle 1. The optical receptacle 1 is integrally formed by injection molding of a light-transmitting resin material, such as polyetherimide (PEI), polycarbonate (PC), polyethersulfone (PES), cyclo olefin polymer (COP), or poly (methyl methacrylate) (PMMA).

As shown in FIG. 7, the optical receptacle 1 has a lens 2 in a substantially center position in a length direction. The lens 2 is formed into a plano-convex lens in which a first face 2a in one optical axis OA direction of the lens 2 (downward in FIG. 7) is a convex face, and a second face 2b in the other optical axis OA direction (upward in FIG. 7) is a planar face perpendicular to the optical axis OA. When viewed from the optical axis OA direction, the faces 2a and 2b of the lens 2 have a circular shape with the optical axis OA as the center (not shown). The first face 2a has a larger diameter than the second face 2b.

In addition, as shown in FIG. 7, the optical receptacle 1 has a photoelectric conversion device attaching section 3 that extends from an outer position in a radial direction in relation to the first face 2a towards one optical axis OA direction (downward in FIG. 7). The photoelectric conversion device attaching section 3 is formed into a cylindrical shape of which an inner circumferential surface is a substantially circular cylindrical surface that is concentric with the optical axis OA.

Furthermore, as shown in FIG. 7, the optical receptacle 1 has an optical fiber attaching section 5 that extends from the outer position in the radial direction in relation to the second face 2b towards a direction in the optical axis OA direction opposite to the photoelectric conversion device attaching section 3. The optical fiber attaching section 5 is formed into a cylindrical shape of which an inner circumferential surface is a substantially circular cylindrical shape that is concentric with the optical axis OA.

Next, FIG. 8 shows an optical module 7 for optical reception as an example of an optical module including the optical receptacle 1, such as that described above.

In other words, as shown in FIG. 8, in the optical module 7, a CAN-package-type photoelectric conversion device 8 including an optical reception function is attached to the photoelectric conversion device attaching section 3 of the optical receptacle 1. More specifically, as shown in FIG. 8, the photoelectric conversion device 8 is configured by, for example: a circular disk-shaped stem 9; a light-receiving element 10, such as a photodetector (PD), mounted on the stem 9; a cap 11 having a window portion 11a for covering and sealing the light-receiving element 10 in an air-tight manner; and a lead 12 through which electrical signals flow based on a light-reception result (photoelectric conversion) of the light-receiving element 10. In addition, attachment of the photoelectric conversion device 8 is performed by an adhesive 13 disposed between the photoelectric conversion device 8 and the photoelectric conversion device attaching section 3 being hardened (adhered) in a state in which a section of a predetermined area of the photoelectric conversion device 8 on the light-receiving element 10 side is inserted into the photoelectric conversion device attaching section 3. As the adhesive 13, a thermoset resin or an ultra-violet hardening resin is used.

In addition, as shown in FIG. 8, in the optical module 7, a section of a long optical fiber 15 on an end portion (end face) 15a side that has a predetermined length is detachably attached, together with a ferrule 17 that holds this section, to the optical fiber attaching section 5. The end portion 15a of the optical fiber 15 faces the second face 2b of the lens 2 with an air layer therebetween, in a state in which the end portion 15a is attached to the optical fiber attaching section 5.

In the optical module 7 for optical reception such as that described above, light including transmission information that has been transmitted from a transmission-side device, such as a semiconductor laser (LD), is transmitted over the optical fiber 15 and emitted from the end portion 15a of the optical fiber 15 towards the lens 2. The light emitted towards the lens 2 is converged by the lens 2 and emitted towards the photoelectric conversion device 8. Thereafter, the light is received by the light-receiving element 10 of the photoelectric conversion device 8. In this way, the end portion 15a of the optical fiber 15 and the light-receiving element 10 are optically coupled.

In the optical module 7 for optical reception such as that described above, a problem occurs in that the light that has been emitted from the end portion 15a of the optical fiber 15 returns to (enters) the end portion 15a of the optical fiber 15 as optical feedback as a result of being Fresnel-reflected at the second face 2b (planar face) of the lens 2. Such optical feedback may turn into noise via the optical fiber 1, and adversely affect the optical output characteristics of a device on the transmission side.

Therefore, to reduce such issues, proposals have been made such as that shown in, for example, Patent Literature 1.

In other words, Patent Literature 1 proposes that a planar optical surface formed on a sleeve be tilted by 4 degrees to 12 degrees in relation to a light-receiving surface of a light-receiving element, thereby suppressing incidence of reflected light attributed to Fresnel reflection at a border between the optical surface and an air layer onto an end portion of an optical fiber as optical feedback.

### PRIOR ART LITERATURES

### Patent Literature

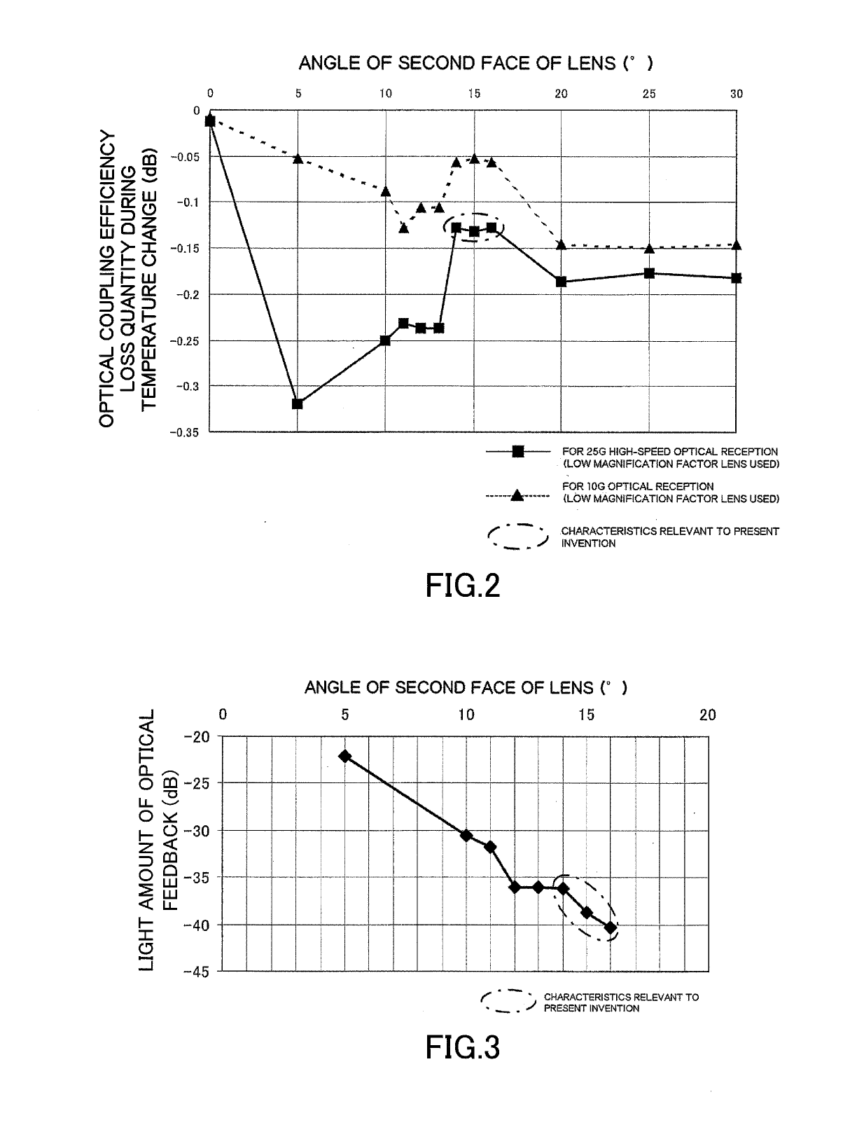

### Patent Literature 1: Japanese Patent Laid-open Publication No. 2006-98763 (FIG. 2 and FIG. 3)

### SUMMARY OF INVENTION

### Problem to be Solved by the Invention

This type of optical module will be required to support increasingly faster optical communication. To meet such needs, light transmitted over an optical fiber at high speed from a device for optical transmission is required to be received at high speed without delay by the light-receiving element. A light-receiving element supporting high-speed optical communication such as this is required to have a small light-receiving area to increase response speed (to shorten the amount of time required from reception of an optical signal at the light-receiving surface until conversion of the optical signal to an electric signal).

However, the configuration described in Patent Literature 1 focuses only on reduction of optical feedback. Therefore, when the light-receiving area of the light-receiving element is reduced to support faster optical reception, a problem occurs in that deterioration of optical performance accompanying temperature change may become significant. In other words, if deformation (linear expansion) of the optical receptacle occurs as a result of temperature change, the optical path of the light passing through the optical receptacle changes in accompaniment. Therefore, in a configuration that does not take this change into consideration, appropriately coupling the outgoing light from the end portion of the optical fiber that has passed through the optical receptacle with the light-receiving element that has a small light-receiving area is difficult.

Therefore, the present invention has been made in light of the above-described issues. An object of the present invention is to provide an optical receptacle capable of effectively reducing optical feedback and ensuring optical stability against temperature change while supporting faster optical reception, and an optical module including the optical receptacle.

### Means for Solving Problem

To achieve the above-described object, an optical receptacle according to claim 1 is an optical receptacle including: a cylindrical optical fiber attaching section for attaching an end portion of an optical fiber; a cylindrical photoelectric conversion device attaching section for attaching a photoelectric conversion device having a light-receiving element; and a lens for optically coupling the end portion of the optical fiber and the light-receiving element. In the optical receptacle, a face of the lens that faces the end portion of the optical fiber is formed into a planar face having a slope angle of 14 degrees to 16 degrees in relation to a virtual plane perpendicular to an optical axis of the lens.

In the invention according to claim 1, even when light emitted from the end portion of the optical fiber is reflected by the face of the lens that faces the end portion of the optical fiber, incidence of the reflected light onto the end portion of the optical fiber as optical feedback can be suppressed. In addition, the light emitted from the end portion of the optical fiber can be appropriately coupled with the light-receiving element regardless of temperature change.

In addition, an optical receptacle according to claim 2 is the optical receptacle according to claim 1 in which, further, the optical receptacle is integrally formed by a resin material.

In the invention according to claim 2, the optical receptacle can be obtained at low cost by resin molding using a mold. In addition, as a result of application of a resin material having a large deformation quantity (coefficient of linear expansion) in accompaniment with temperature change, the significance of reduction in degradation of optical performance accompanying temperature change becomes greater.

Furthermore, an optical receptacle according to claim 3 is the optical receptacle according to claims 1 or 2 in which, further, a predetermined low magnification factor can be selected as a magnification factor of the lens.

In the invention according to claim 3, even when a lens is selected that has a low magnification factor of which degradation in optical performance accompanying temperature change tends to be significant compared to a lens having a high magnification factor, the degradation of optical performance accompanying temperature change can be sufficiently reduced. Therefore, during selection of the magnification factor of the lens, no significant restrictions are applied on the low magnification factor side. The degree of freedom of design can be widened.

Still further, an optical module according to claim 4 includes: an optical receptacle according to any one of claims 1 to 3; a photoelectric conversion device according to claim 1; and an optical fiber according to claim 1. In the optical module, a light-receiving element of the photoelectric conversion device is formed having a light-receiving area of a predetermined value or less.

In the optical module according to claim 4, optical feedback can be effectively reduced. In addition, as a result of a light-receiving element having a small light-receiving area being used, optical stability against temperature change can be ensured while supporting faster optical reception.

### Effect of the Invention

In the present invention, optical feedback can be effectively reduced, and optical stability against temperature change can be ensured while supporting faster optical reception.

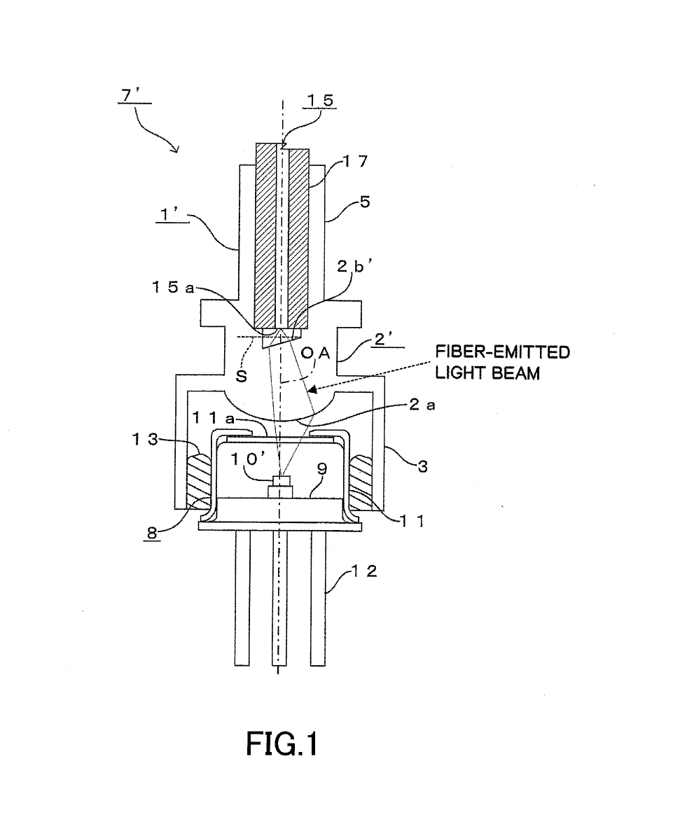

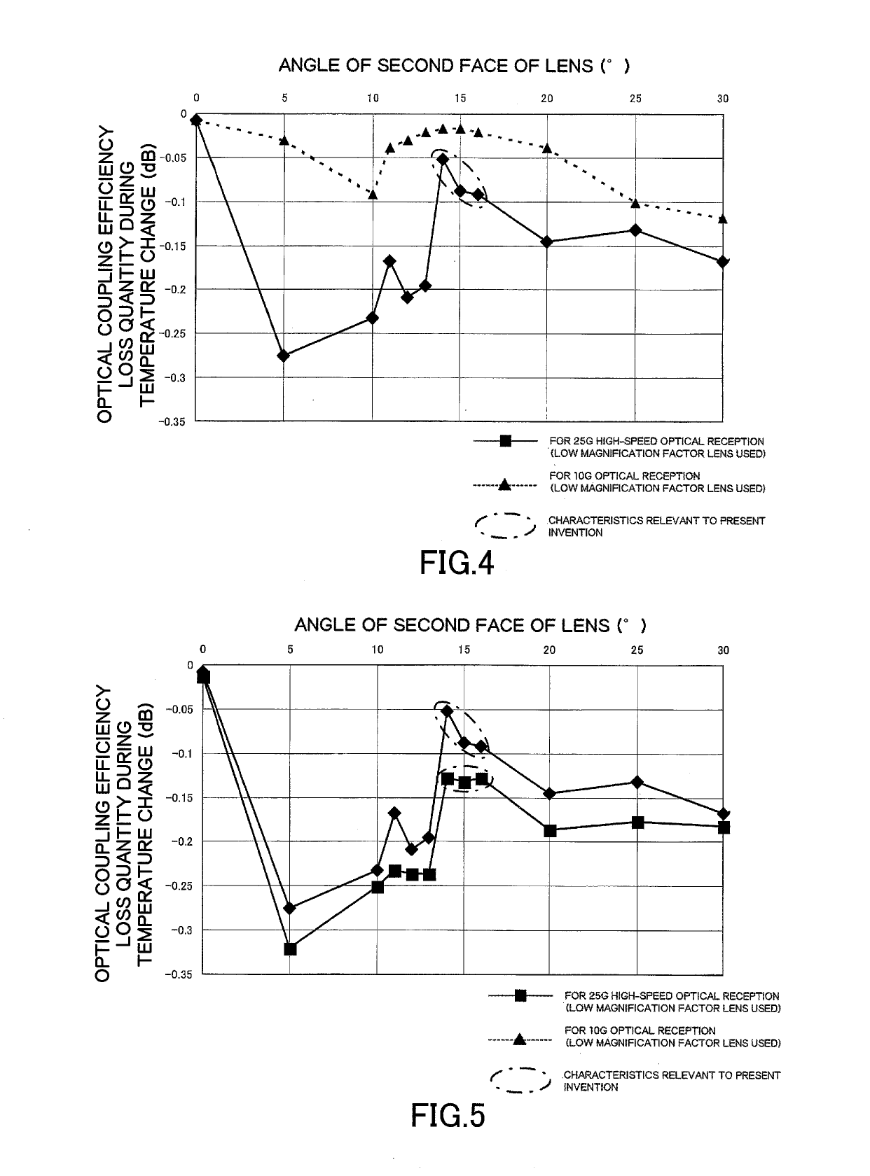

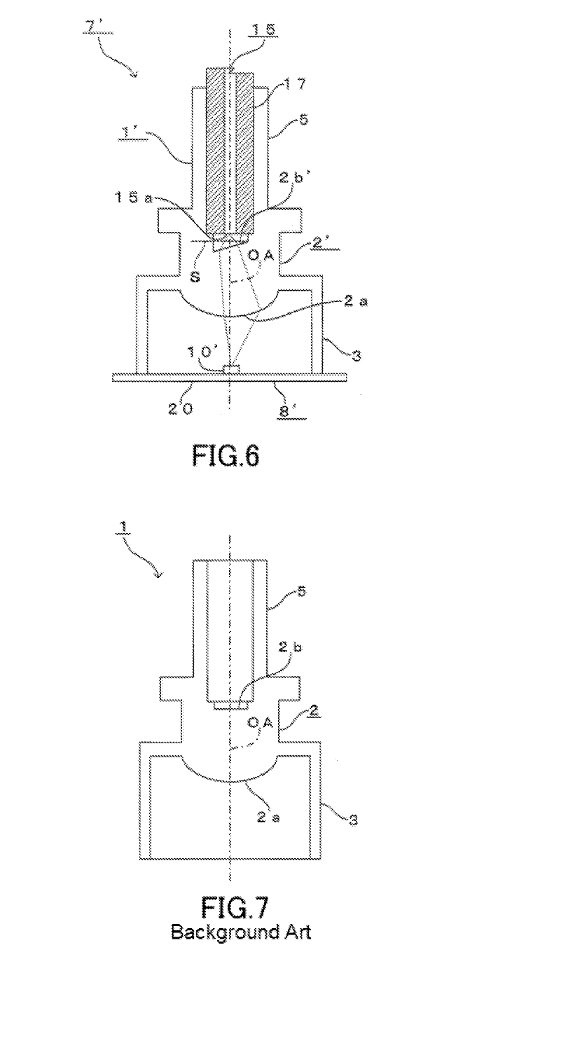

### BRIEF DESCRIPTION OF DRAWINGS

[FIG. 1] An vertical cross-sectional view of an optical receptacle and an optical module according to an embodiment of the present invention.

[FIG. 2] A graph showing, as results of a first simulation, the results of a simulation performed for each slope angle of a second face of a lens regarding degradation characteristics of optical coupling efficiency accompanying temperature change, the simulation performed on a light-receiving element having a small light-receiving area for 25 Gbps high-speed optical reception and a light-receiving element having a relatively large light-receiving area for conventional 10 Gbps optical reception while using a lens having a low magnification factor.

[FIG. 3] A graph showing, as results of a second simulation, the results of a simulation performed regarding characteristics of light amount of optical feedback in relation to the slope angle of the second face of the lens.

[FIG. 4] A graph showing, as results of a third simulation, the results of a simulation performed for each slope angle of the second face of the lens regarding degradation characteristics of optical coupling efficiency accompanying temperature change, the simulation performed on a light-receiving element for 25 Gbps high-speed optical reception and a light-receiving element for conventional 10 Gbps optical reception while using a lens having a high magnification factor.

[FIG. 5] A graph showing as results of a fourth simulation, the results of a simulation performed for each slope angle of the second face of the lens regarding degradation characteristics of optical coupling efficiency accompanying temperature change, the simulation performed on a light-receiving element for 25 Gbps high-speed optical reception while using a lens having a low magnification factor and a lens having a high magnification factor.

[FIG. 6] A configuration diagram of a variation example of the present invention.

[FIG. 7] A vertical cross-sectional view of an example of a conventional optical receptacle.

[FIG. 8] A vertical cross-sectional view of an optical module including the optical receptacle shown in FIG. 7.

### BEST MODE(S) FOR CARRYING OUT THE INVENTION

An embodiment of an optical receptacle and an optical module of the present invention will hereinafter be described with reference to FIG. 1 to FIG. 6, focusing on differences with those in the past.

Sections of which the basic configuration is the same or similar as that in the past are described using the same reference numbers.

As shown in FIG. 1, in a manner similar to the conventional optical receptacle 1, an optical receptacle 1′ according to the present embodiment is configured by constituent sections that are a lens 2′, a photoelectric conversion device attaching section 3, and an optical fiber attaching section 5. The constituent sections 2′, 3, and 5 are integrally molded by injection molding of a resin material using a mold.

The optical receptacle 1′ according to the present embodiment differs from that of the past in terms of the configuration of a second face 2b′ of the lens 2′ (a face facing an end portion 15a of an optical fiber 15).

In other words, as shown in FIG. 1, according to the present embodiment, the second face 2b′ of the lens 2′ is not a planar face that is perpendicular to an optical axis OA as that in the past. Rather, the second face 2b′ is formed into a planar face having a predetermined slope angle in an angle range of 14 degrees to 16 degrees (14 degrees or more and 16 degrees or less) in relation to a virtual surface S that is perpendicular to the optical axis OA. However, according to the present embodiment as well, the center of the second face 2b′ may be positioned on the optical axis OA.

In addition, the optical module 7′ according to the present embodiment differs from that of the past in that, in addition to the above-described difference in the configuration of the optical receptacle 1′, the light-receiving area of a light-receiving element 10′ is formed to be smaller than that of a conventional light-receiving element 10. When high-speed optical reception of 25 Gbps or more is supported, in the instance of a circular light-receiving surface, the light-receiving area is preferably φ30 μm or less. In addition, the light-receiving element 10′ may be positioned based on a design in which the center of the light-receiving surface matches a light-focusing point (focal point) of the lens 2′ at a set temperature (such as room temperature). In this instance, the position of the center of the light-receiving element may be shifted from the optical axis OA of the lens 2′ in a direction perpendicular to the optical axis OA.

In a configuration such as that described above, as a result of the second face 2b′ of the lens 2′ being given a slope angle within an optimal angle range, even when Fresnel reflection of the light emitted from the end portion 15a of the optical fiber 15 occurs at the second face 2b′, incidence of the reflected light onto the end portion 15a of the optical fiber 15 as optical feedback can be suppressed. Furthermore, in the configuration such as that described above, the light emitted from the end portion 15a of the optical fiber 15 can be appropriately coupled with the light-receiving element 10′ having a small light-receiving area by the lens 2′, regardless of temperature change. In particular, when the optical receptacle 1′ is formed by a resin material having a large coefficient of linear expansion as according to the present embodiment, the significance of reduction in degradation of optical performance accompanying temperature change is great.

In addition, according to the present embodiment, a predetermined low magnification factor can be selected as the magnification factor of the lens 2′. As the low magnification factor, for example, ×1 magnification can be used. In other words, according to the present embodiment, even when a lens is selected that has a low magnification factor (such as ×1 magnification) of which degradation in optical performance accompanying temperature change tends to be significant compared to a lens having a high magnification factor (such as ×1.5 magnification), the degradation of optical performance can be sufficiently reduced. Therefore, no significant restrictions are applied on the low magnification factor side regarding the magnification factor of the lens. The degree of freedom of module design including the lens can be widened.

### EXAMPLES

Next, various simulations were performed to evaluate optical performance of the optical receptacle 1′ and the optical module 7′ of the present invention in the present examples.

### First Simulation

In other words, first, in a first simulation, simulation was performed for each slope angle of the second face of the lens regarding the degradation characteristics appearing in optical coupling efficiency between the optical fiber and the light-receiving element in accompaniment with temperature change, the simulation being performed on a light-receiving element having a light-receiving area of φ30 μm for 25 Gbps high-speed optical reception and a light-receiving element having a light-receiving area of φ50 μm for conventional 10 Gbps high-speed optical reception, when a lens having a low magnification factor of ×1.0 magnification is used. However, in the present simulation, the optical fiber is a single-mode-type optical fiber. The used light that is used for optical coupling between the optical fiber and the light-receiving element is a light having a wavelength of 1550 nm. Furthermore, the optical receptacle is made of PEI. In the present simulation, during the process of changing the angle of the second face of the lens by a predetermined degree within the angle range of 0 degrees to 30 degrees with reference to a plane that is perpendicular to the optical axis OA (0 degrees), for each angle, a difference between a maximum value and a minimum value of optical coupling efficiency indicated when the temperature is changed within a range of −40° C. to 85° C. was plotted on a graph as loss quantity of optical coupling efficiency in correspondence with the angle.

The results of the first simulation such as that described above are shown in FIG. 2. In FIG. 2, the vertical axis indicates the loss quantity (dB) of optical coupling efficiency accompanying temperature change. The horizontal axis indicates the angle (degree) of the second face of the lens. Here, in FIG. 2, among the characteristics (▪-plot solid line graph) of the light-receiving element for 25 Gbps high-speed optical reception, the characteristics of when the angle (horizontal axis) is in the range of 14 degrees to 16 degrees are the characteristics relevant to the configuration of the present invention. As shown in FIG. 2, in the configuration of the present invention, even when temperature change occurs, it is clear that decrease in optical coupling efficiency of the light-receiving element for 25 Gbps high-speed optical reception can be kept small compared to many configurations in which the angle of the second face of the lens exceeds the angle range (14 degrees to 16 degrees) of the present invention. Specifically, in the configuration of the present invention, the loss quantity of optical coupling efficiency during temperature change is −0.13 dB. The value is a sufficiently small loss quantity comparable with the loss quantity indicated by the characteristics (▴-plot broken line graph) of the light-receiving element for 10 Gbps optical reception. With this degree of loss quantity, practical use can be sufficiently withstood, and favorable optical coupling efficiency can be actualized. On the other hand, in the angle range (4 degrees to 12 degrees) set in Patent Literature 1, the decrease in optical coupling efficiency accompanying temperature change is large. In particular, when the angle of the second face of the lens is 5°, the loss quantity of optical coupling efficiency indicates a maximum value of −0.32 dB. In the angle range near 0 degrees to 2 degrees, the decrease in optical coupling efficiency is smaller than that of the configuration of the present invention. However, the angle range is unfavorable in terms of reduction in optical feedback, as shown in the results of a following second simulation.

According to the results of the first simulation such as that described above, when the angle of the second face of the lens is 14 degrees to 16 degrees as in the present invention, in an instance in which a lens having a low magnification factor is used, optical stability accompanying temperature change can be ensured while supporting 25 Gbps high-speed optical reception.

### Second Simulation

Next, in the second simulation, simulation is performed regarding the characteristics of the light amount of optical feed back in relation to the angle of the second face of the lens. The type of optical fiber and the wavelength of the used light for the present simulation are similar to those of the first simulation. In addition, in the present simulation, it is presumed that the light emitted from the end face of the optical fiber is reflected at 100% reflectance by the second face of the lens.

The results of the second simulation such as that described above are shown in FIG. 3. In FIG. 3, the vertical axis indicates the light amount (dB) of optical feedback. The horizontal axis indicates the angle of the second face of the lens with reference to a plane that is perpendicular to the optical axis OA (0 degrees). Here, in a manner similar to that in FIG. 2, the characteristics (within the dashed line frame) of when the angle (horizontal axis) is in the range of 14 degrees to 16 degrees are the characteristics relevant to the configuration of the present invention in FIG. 3. As shown in FIG. 3, it is clear that, in the configuration of the present invention, the light amount of optical feedback can be substantially reduced to a value within a range of −36 dB to −40 dB. The value causes no issues in practical use and is sufficiently small enough to be allowable even should the value slightly increase as a result of manufacturing error. On the other hand, in the angle range (4 degrees to 12 degrees) set in Patent Literature 1, the light amount of optical feedback is substantially within a range of −20 dB to −36 dB. The noise reduction effect is lower than that of the configuration of the present invention. The reason for setting the upper limit of the angle range of the planar optical surface to 12 degrees in Patent Literature 1 is because, at an angle greater than 12 degrees, the light that has been emitted from the end face of the optical fiber and is advancing towards the light-receiving element is significantly refracted by the optical surface, thereby shifting the light-focusing point on the light-receiving element side from the optical axis in a direction perpendicular to the optical axis. In this regard, in the present invention, offset setting of the light-receiving element in the direction perpendicular to the optical axis can be performed in adherence to design during modularization (during assembly). Therefore, the issue raised in Patent Literature 1 can be prevented in advance.

According to the results of the second simulation such as that described above, it is clear that optical feedback can be sufficiently reduced when the angle of the second face of the lens is 14 degrees to 16 degrees as in the present invention.

### Third Simulation

Next, in a third simulation, simulation was performed for each slope angle of the second face of the lens regarding the degradation characteristics appearing in optical coupling efficiency between the optical fiber and the light-receiving element in accompaniment with temperature change, the simulation being performed on a light-receiving element having a light-receiving area of φ30 μm for 25 Gbps high-speed optical reception and a light-receiving element having a light-receiving area of φ50 μm for conventional 10 Gbps high-speed optical reception, when a lens having a high magnification factor of ×1.5 magnification is used. However, in the present simulation, conditions such as the type of optical fiber, the wavelength of the used light, the forming material of the optical receptacle, the angle range of the second face of the lens, the range of temperature change, and the method of calculating the loss quantity of optical coupling efficiency, are similar to those of the first simulation.

The results of the third simulation such as that described above are shown in FIG. 4. An overview of the graph in FIG. 4 is similar to that in FIG. 2. In FIG. 4, among the characteristics (♦-plot solid line graph) of the light-receiving element for 25 Gbps high-speed optical reception, the characteristics (within the dashed line frame) of when the angle (horizontal axis) is in the range of 14 degrees to 16 degrees are the characteristics relevant to the configuration of the present invention. As shown in FIG. 4, in the configuration of the present invention, even when temperature change occurs, it is clear that decrease in optical coupling efficiency of the light-receiving element for 25 Gbps high-speed optical reception can be kept small compared to many configurations in which the angle of the second face of the lens exceeds the angle range (14 degrees to 16 degrees) of the present invention. Specifically, in the configuration of the present invention, the loss quantity of optical coupling efficiency during temperature change is about −0.09 dB at maximum. The value indicates a loss quantity that is smaller than that of the configuration of the present invention using a low magnification factor lens (the instance in FIG. 2). On the other hand, in the angle range (4 degrees to 12 degrees) set in Patent Literature 1, the decrease in optical coupling efficiency accompanying temperature change is large. In particular, when the angle of the second face of the lens is 5°, the loss quantity of optical coupling efficiency indicates a maximum value of −0.275 dB.

According to the results of the third simulation such as that described above, when the angle of the second face of the lens is 14 degrees to 16 degrees as in the present invention, optical stability accompanying temperature change can be ensured while supporting 25 Gbps high-speed optical reception, even in an instance in which a lens having a high magnification factor is used.

### Fourth Simulation

Next, in a fourth simulation, simulation was performed for each slope angle of the second face of the lens regarding the degradation characteristics appearing in optical coupling efficiency between the optical fiber and the light-receiving element in accompaniment with temperature change, the simulation being performed on a light-receiving element having a light-receiving area of φ30 μm for 25 Gbps high-speed optical reception when a lens having a low magnification factor of ×1.0 magnification and a lens having a high magnification factor of ×1.5 magnification are used.

The results of the present simulation are equivalent to a comparison of the characteristics of the light-receiving element for high-speed optical reception shown in FIG. 2 and the characteristics of the light-receiving element for high-speed optical reception shown in FIG. 4. In other words, the results of the present simulation are as shown in FIG. 5. As shown in FIG. 5, in the instance in which the lens having a low magnification factor is applied, it is clear that the decrease in optical coupling efficiency accompanying temperature change increases compared to the instance in which the lens having a high magnification factor is applied. In the present invention, even when the lens having a low magnification factor in which such decrease is significant is applied, degradation of optical coupling efficiency can be sufficiently reduced as a result of the second face of the lens being given an optical angle range.

According to the results of the fourth simulation such as that described above, when the angle of the second face of the lens is 14 degrees to 16 degrees as in the present invention, either a high magnification factor or a low magnification factor can be selected as the magnification factor of the lens. It is clear that the degree of freedom of design can be widened.

As described above, in the present invention, as a result of a simple design in which the second face of the lens is formed into a sloped plane of 14 degrees to 16 degrees, optical feedback can be effectively reduced and optical stability against temperature change can be ensured while supporting faster optical reception. In addition, compared to an instance in which an anti-reflection (AR) coating for optical feedback reduction is formed on the second face 2b, the number of components and cost can be reduced.

The present invention is not limited to the above-described embodiment and may be variously modified to the extent that features thereof are not compromised.

For example, the first face 2a of the lens 2 may be spherical or aspherical.

In addition, as shown in FIG. 6, instead of the CAN-package-type photoelectric conversion device 8, a substrate-mounted photoelectric conversion device 8′ in which the light-receiving element 10′ is mounted on a semiconductor substrate 20 may be used.

Furthermore, the present invention can also be effectively applied to a multi-mode optical fiber, in addition to the single-mode optical fiber.

### EXPLANATIONS OF LETTERS OR NUMERALS

1′ optical receptacle
2′ lens
2b′ second face
3 photoelectric conversion device attaching section
5 optical fiber attaching section
8 photoelectric conversion device
10′ light-receiving element
15 optical fiber
15a end portion

1. An optical receptacle comprising:
a cylindrical optical fiber attaching section for attaching an end portion of an optical fiber;
a cylindrical photoelectric conversion device attaching section for attaching a photoelectric conversion device having a light-receiving element; and
a lens for optically coupling the end portion of the optical fiber and the light-receiving element, wherein
a face of the lens that faces the end portion of the optical fiber is formed into a planar face having a slope angle of 14 degrees to 16 degrees in relation to a virtual plane perpendicular to an optical axis of the lens.

2. The optical receptacle according to claim 1, wherein:
the optical receptacle is integrally formed by a resin material.

3. The optical receptacle according to claim 1, wherein:
a predetermined low magnification factor can be selected as a magnification factor of the lens.

4. An optical module comprising:
an optical receptacle according to claim 1;
a photoelectric conversion device attached to a cylindrical photoelectric conversion device attaching section included in the optical receptacle; and
an optical fiber, an end portion of which is attached to a cylindrical optical fiber attaching section included in the optical receptacle, wherein:
a light-receiving element of the photoelectric conversion device is formed having a light-receiving area of a predetermined value or less.

5. The optical receptacle according to claim 2, wherein:
a predetermined low magnification factor can be selected as a magnification factor of the lens.

6. An optical module comprising:
an optical receptacle according to claim 2;
a photoelectric conversion device attached to a cylindrical photoelectric conversion device attaching section included in the optical receptacle; and
an optical fiber, an end portion of which is attached to a cylindrical optical fiber attaching section included in the optical receptacle, wherein:
a light-receiving element of the photoelectric conversion device is formed having a light-receiving area of a predetermined value or less.

7. An optical module comprising:
an optical receptacle according to claim 3;
a photoelectric conversion device attached to a cylindrical photoelectric conversion device attaching section included in the optical receptacle; and
an optical fiber, an end portion of which is attached to a cylindrical optical fiber attaching section included in the optical receptacle, wherein:
a light-receiving element of the photoelectric conversion device is formed having a light-receiving area of a predetermined value or less.

8. An optical module comprising:
an optical receptacle according to claim 5;
a photoelectric conversion device attached to a cylindrical photoelectric conversion device attaching section included in the optical receptacle; and
an optical fiber, an end portion of which is attached to a cylindrical optical fiber attaching section included in the optical receptacle, wherein:
a light-receiving element of the photoelectric conversion device is formed having a light-receiving area of a predetermined value or less.
